(19) United States
(12) Patent Application Publication
(10) Pub. No.: US 2011/0072819 A1
(43) Pub. Date: Mar. 31, 2011

(54) HEAT RECOVERY SYSTEM BASED ON THE USE OF A STABILIZED ORGANIC RANKINE FLUID, AND RELATED PROCESSES AND DEVICES

(75) Inventors: James Manio Silva, Clifton Park, NY (US); Thomas Johannes Frey, Ingolstadt (DE); James Edward Pickett, Schenectady, NY (US)

(73) Assignee: GENERAL ELECTRIC COMPANY, SCHENECTADY, NY (US)

(21) Appl. No.: 12/568,051

(22) Filed: Sep. 28, 2009

(51) Int. Cl. F01K 23/06; F01K 25/08; F01K 23/10; G01N 21/00

(52) U.S. Cl. 60/651; 60/671; 60/39.181; 422/82.05

(57) ABSTRACT

A heat recovery system is disclosed, and includes a thermally-stable, organic working fluid which is based on a mixture of thiophene or a derivative thereof, and at least one hydrocarbon having a boiling point in the range of about 25° C. to about 125° C. A method for recovering waste-heat from a power plant is also described, and includes the step of directing the waste-heat to the heat-recovery system as described herein. A photometric sensor system for the detection of oxidative activity in an industrial process is disclosed, and includes the working fluid described above, and a detector for detecting a color change in the fluid, which signifies oxidative activity.

### BACKGROUND

This invention generally relates to systems and processes for recovering and utilizing waste heat. More specifically, the invention relates to organic rankine cycle (ORC) systems which benefit from improved working fluids, and to methods for recovering waste heat from various sources, such as power plants.

Large amounts of waste heat are generated by many different types of industrial and commercial operations. Examples of the heat sources are combustion engines, combustion turbines; nuclear power plants, coal-burning plants; and coal gasification plants. One method of generating electricity from these types of waste heat is to apply a rankine cycle.

Fundamentally, the rankine cycle is often water- or steam-based, and usually includes a turbine-generator, an evaporator/boiler, a condenser, and a liquid pump. While water/steam-based rankine cycles are useful for recovering heat at relatively high temperatures, organic rankine cycles (ORC's) are very efficient at recovering heat from some of the lower-temperature operations mentioned above, e.g., at temperatures of about 100-300° C. Moreover, organic rankine cycles are currently being developed to recover heat from higher-temperature heat sources, e.g., up to about 450° C.

A number of working fluids have been used or considered for use in organic rankine cycles Examples include thiophene, various hydrofluorocarbons, pentanes, butanes, and silicone oils. In terms of physical and thermodynamic properties (e.g., vapor pressure, vaporization enthalpy, and normal boiling point characteristics), thiophene is an especially attractive candidate for advanced organic rankine cycles.

While thiophene has many desirable properties for this application, there is a key drawback as well. The compound is very susceptible to oxidation at temperatures of about 300° C. or more. Thus, in the presence of even small amounts of oxygen, the compound can oxidize rapidly, yielding byproducts such as acidic off-gasses. The byproducts may cause various problems, such as corrosion within the heat recovery system, e.g., within piping and heat-exchange systems. Most heat recovery systems require working fluids which are stable for several years or more. Therefore, the propensity for thiophene oxidation makes it less attractive for this purpose—especially because of the fact that oxygen can inadvertently enter the heat recovery system in a number of ways, e.g., through various seals in the apparatus.

In view of these considerations, it can be seen that new working fluids for heat recovery systems would be welcome in the art. Moreover, since thiophene may be an ideal working fluid for some systems based on the organic rankine cycle, modified fluids based on thiophene would be of special interest. The new working fluids should exhibit oxidative stability at elevated temperatures, while also possessing the thermodynamic properties needed for efficient heat capture. They should also be compatible with the heat-recovery equipment, and relatively economical to incorporate into a commercial system.

### BRIEF DESCRIPTION OF THE INVENTION

One embodiment of this invention is directed to a heat recovery system. The system includes a thermally-stable, organic working fluid which comprises a mixture of thiophene or a derivative thereof, and at least one hydrocarbon having a boiling point in the range of about 25° C. to about 125° C. The hydrocarbon is present at a level of about 1% to about 25% by weight, based on the weight of the mixture.

Another embodiment is directed to a waste-heat recovery system, comprising at least one organic working cycle. The organic working cycle includes a working fluid which comprises a mixture of thiophene or a derivative thereof, and at least one hydrocarbon having a boiling point in the range of about 25° C. to about 125° C.

An additional embodiment relates to a method for recovering waste-heat from a power plant. The method comprises the step of directing the waste-heat to a heat-recovery system as described herein, so as to function as at least a portion of the heat source in the system.

Still another embodiment is directed to a photometric sensor system for the detection of oxidative activity in an industrial process which is carried out at elevated temperatures, and which utilizes at least one fluid. The fluid comprises a mixture of a thiophene-based compound and at least one hydrocarbon, and changes color upon oxidation. The sensor system further comprises at least one detector in optical contact with the fluid. The detector is capable of detecting a color change in the fluid, as further described below.

Another embodiment relates to a method for detecting oxidative activity in an industrial process which is carried out at elevated temperatures, and which utilizes at least one fluid, as described herein. The method comprises the step of measuring color changes in the fluid with a color-change detector. The oxygen-sensitive fluid possesses a specific color at an initial time setting, and then undergoes a measurable color change over time upon exposure to oxygen. The color change can be correlated to oxidation of the hydrocarbon, which is indicative of oxidative activity in the industrial process.

### BRIEF DESCRIPTION OF THE DRAWINGS

FIG. 1 is a schematic of an exemplary heat recovery system based on some of the embodiments of the present invention.

FIG. 2 is a schematic of an exemplary photometric sensor system according to some embodiments of this invention.

### DETAILED DESCRIPTION OF THE INVENTION

The compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity). The suffix “(s)” as used herein is intended to include both the singular and the plural of the term that it modifies, thereby including one or more of that term (e.g., “the compound” may include one or more compounds, unless otherwise specified). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

As mentioned above, the organic working fluid for the present invention comprises thiophene, or a derivative thereof. Thiophene has the empirical formula C₄H₄S, and is a heterocyclic, aromatic compound, having a five-membered ring. As used herein, a “derivative” of thiophene can be any closely-related compound in structure, but is usually a compound in which one of the hydrogen atoms is substituted with a methyl group or with a halogen, i.e., fluorine, chlorine, bromine, or iodine. (While the term “thiophene” is used primarily herein, it should be understood that the derivatives are implied as well).

The working fluid further includes at least one hydrocarbon compound. A number of hydrocarbons can be used in combination with thiophene. Usually, the hydrocarbon has a boiling point in the range of about 25° C. to about 125° C. The hydrocarbon compounds can be aromatic, aliphatic, or cycloaliphatic. As further described below, one theory (and as such, non-binding) regarding the benefit of the hydrocarbon is that the hydrocarbon constituent appears to function as a “scavenger” for oxygen within the heat recovery system. Thus, the hydrocarbon is preferentially oxidized, thereby impeding or preventing the oxidation of the thiophene constituent for an extended period of time.

Examples of the aromatic compounds are toluene and various xylenes (e.g., ortho-, meta-, or para-xylene). Combinations of any of these materials may be used as well. (Benzene might also be used, but is typically not preferred because of environmental and health concerns).

Non-limiting examples of suitable aliphatic compounds include iso-pentane; n-pentane; 2,3-dimethylbutane; 2,2-dimethylbutane; 2-methylpentane; 3-methylpentane; n-hexane; 2,2-dimethylpentane; 2,4-dimethylpentane; 2,2,3-trimethylbutane; 3,3-dimethylpentane; 2,3-dimethylpentane; 2-methylhexane; 3-methylhexane; 3-ethylpentane; n-heptane; 2,2,4-trimethylpentane; 2,2-dimethylhexane; 2,5-dimethylhexane; 2,4-dimethylhexane; 2,2,3-trimethylpentane; 3,3-dimethylhexane; 2,3,4-trimethylpentane; 2,3,3-trimethylpentane; 2,3-dimethylhexane; 2-methylheptane; 4-methylheptane; 3,4-dimethylhexane; 3-methyl-3-ethylpentane; 3-ethylhexane; 3-methylheptane; 2,2,4,4-tetraethylpentane; 2,2,5-trimethylhexane; n-octane; 2,2,4-trimethylhexane; and various combinations thereof. In some preferred embodiments, the aliphatic compound is selected from the group consisting of iso-pentane, n-pentane, 2-methylpentane; 3-methylpentane; n-hexane; and various combinations thereof.

Non-limiting examples of suitable cycloaliphatic compounds include cyclopentane; methylcyclopentane; cyclohexane; 1,1-dimethylcyclopentane; trans-1,2 dimethylcyclopentane; cis-1,2 dimethylcyclopentane; methylcyclohexane; ethylcyclopentane; 1,1,3-trimethylcyclopropane; cis-trans-cis-1,2,4-trimethylcyclopropane; 1,1,2-trimethylcyclopropane; cis-cis-trans-1,2,4-trimethylcyclopropane; cycloheptane; trans-1,4-dimethylcyclohexane; 1,1-dimethylcyclohexane; cis-1,3-dimethylcyclohexane; 1-methyl-1-ethylcyclopropane; trans-1,2-dimethylcyclohexane; cis-1,4-dimethylcyclohexane; trans-1,3-dimethylcyclohexane; and combinations thereof. In some preferred embodiments, the cycloaliphatic compound is selected from the group consisting of cyclopentane; methylcyclopentane; cyclohexane, and various combinations thereof; with cyclopentane itself being most preferred for some applications.

The relative amounts of thiophene and the hydrocarbon compound(s) in the mixture can vary significantly. Various factors are used to determine how much hydrocarbon is appropriate. They include the specific hydrocarbon employed, and its own chemical and physical properties (e.g., normal boiling point); the type of heat recovery system in use; the general temperature range at which the working fluid will be vaporized and carried through the system; and estimates of potential air or oxygen leakage into the heat recovery system. In general, enough thiophene should be present to obtain the thermodynamic benefits of such a compound, while enough hydrocarbon should be present to, in effect, thermally-stabilize the thiophene. Usually, the hydrocarbon (total amount) is present at a level in the range of about 1% to about 25% by weight, based on the weight of the mixture. In some specific embodiments, the level of hydrocarbon is about 5% by weight to about 20% by weight, and most often, about 5% by weight to about 10% by weight.

As mentioned previously, another embodiment of this invention relates to a heat recovery system, utilizing the thermally-stable organic working fluid discussed previously. A large variety of heat recovery systems can be employed in this embodiment, and substantially all of them operate on the principle of the organic rankine cycle. Non-limiting examples of various configurations are found in U.S. Pat. No. 7,225,621 (Zimron et al); U.S. Pat. No. 7,174,716 (Brasz et al); and U.S. Patent Publication 2009/0000299 (Ast et al), all of which are incorporated herein by reference.

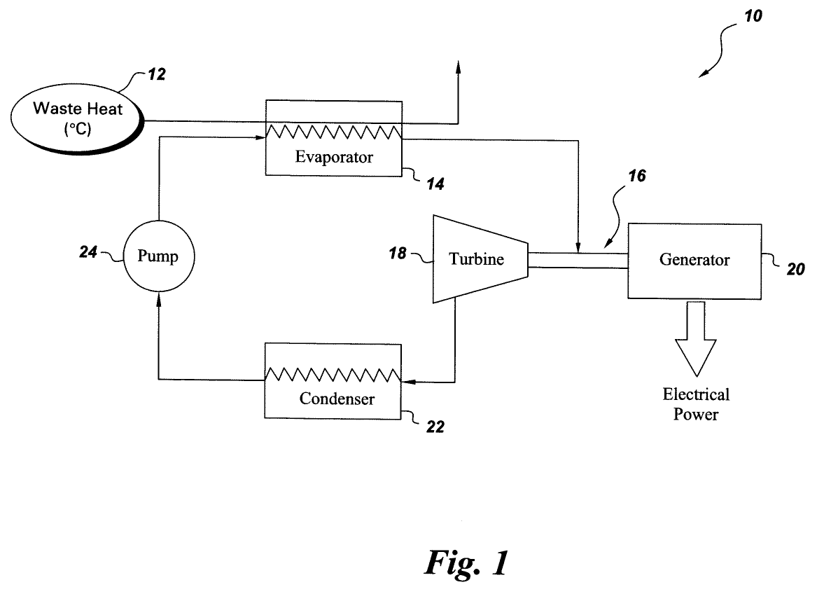

FIG. 1 depicts a simplified, exemplary heat recovery system 10, which utilizes waste heat (or any other type of process heat) from at least one source 12. Non-limiting examples of the heat source include: combustion engines, combustion turbines; nuclear power plants, coal-burning plants; coal gasification plants; petroleum coke gasification systems; steam plants; geothermal systems, biomass combustion systems, municipal waste combustion systems; municipal waste gasification systems; space heating assemblies; general cooling systems; and various combinations thereof. (In other words, there could be multiple waste heat sources 12). The waste-heat temperature will vary, depending on the source, and in some embodiments, is in the range of about 200° C. to about 600° C.

The waste heat from source 12 is directed to an evaporator (e.g., a boiler) 14, in which the organic working fluid (not specifically shown) is vaporized. Those skilled in the art understand that the working fluid being heated may be contained in one or more heat exchanger systems, and these systems then direct the heated fluid to the evaporator. Moreover, a number of pumps may be employed in the system.

The vaporized working fluid is then directed to a turbine-generator system 16. The particular type of turbine-generator system is not critical to this invention. Many variations of each individual component (i.e., the turbine 18 and the generator 20) are possible, and their arrangement can vary as well. The vaporized working fluid expands in the turbine-generator 16, producing electrical power, via the generator. The electrical power output can be directed to any number of sites, e.g., to feed a common base load, such as a power utility grid.

An organic fluid condenser 22 is in direct- or indirect communication with the turbine-generator system 16. The condenser 22 condenses the vaporized, expanded working fluid after it exits system 16, so that the fluid is again returned to its liquid state. A pump 24 or other suitable means is then used to direct the condensed fluid back to evaporator 14, to begin the cycle again. Heat from the condensation step can be transferred to cooling water; can be directed to another heat-recovery unit or boiler; or can be used for any other conventional purpose.

Again, many variations are possible, in terms of each unit of the heat recovery system. Several of the variations are described in the patent publication of Ast et al, described previously. Some embodiments described therein rely on two rankine cycles, which can efficiently utilize waste heat from at least two different sources. Each cycle can include its own working fluid, which may comprise the composition described herein. The configuration in the Ast reference also includes a cascaded heat exchange unit, through which the working fluids can circulate. In any of the various heat recovery systems which can be designed, the use of a working fluid which is very stable at relatively high temperatures, for extended periods of time, represents a distinct system advantage.

As mentioned previously, another embodiment of this invention is directed to a photometric sensor, i.e., a “sensor system”. The sensor is based on a discovery of the present inventors, regarding changes in color which were observed, during the course of oxidative activity within the working fluid composition. The sensor comprises at least a portion of the working fluid, i.e., the mixture of a thiophene-based compound and at least one hydrocarbon, as described previously. The sensor further comprises a detector means. The detector means can be in optical contact (e.g., through a sight glass) with the working fluid mixture, and may be used to monitor changes in fluid color, which indicates oxidative activity. The detector means may be electronic (e.g. a color-sensitive photodetector), or it may be based on visual observation by an operator.

The thiophene/hydrocarbon mixture possesses a specific color at an initial time. The mixture then undergoes a measurable color change over time, which can be correlated to oxidation of the hydrocarbon compound. As explained previously, oxidation of the hydrocarbon represents a signal that oxidative activity is occurring in the industrial process, e.g., in a heat recovery system in which the oxygen-sensitive mixture is the working fluid. Thus, in one embodiment (usually a higher temperature environment), it is possible to employ the sensor to determine how much oxygen or oxygen-containing gas has entered the system in which the sensor is operating. Such a determination can be very useful for many different types of systems and processes, one of which is the ORC-based system described herein.

It should be understood that photometric sensors may include a number of features and related components. Non-limiting examples include color filter arrays; electrical circuitry; recording equipment; image sensors; shade guides; photocells, photoarray detectors, light-emitting diodes (LEDs), and light meters. One or more of these features and components can be incorporated into the present sensor system, by those skilled in the art.

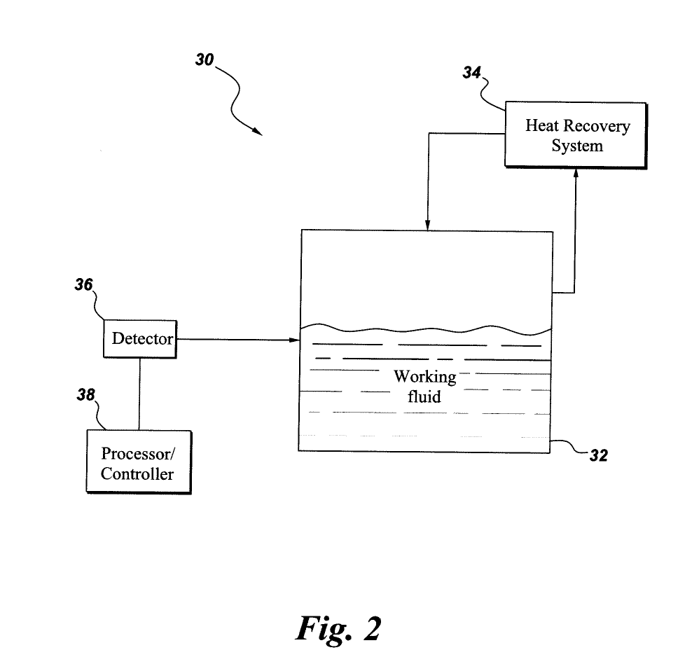

FIG. 2 is a non-limiting, simplified illustration of the sensor system 30. The system includes working fluid 32, which may function, for example, as part of a heat recovery system 34, as described herein, e.g., in FIG. 1. The working fluid can be monitored in-line, i.e., during its passage through the heat recovery system; or it can be a liquid sample which is periodically diverted or taken from the system.

Detector 36 can constitute any means for determining color and change-in-color, e.g., a color-sensitive photodetector, which is known in the art. Moreover, one or more conventional processor/controller devices 38 can be used to coordinate and process data obtained from the detector. As mentioned previously, the detector may alternatively (or additionally) be based on observation by an operator.

### Examples

The example presented below is intended to be merely illustrative, and should not be construed to be any sort of limitation on the scope of the claimed invention.

Various samples of working fluids were tested for thermal stability. In one set of tests, a 10 cc stainless steel bomb was initially placed in a 300° C. oven for a week under an air atmosphere, to pre-oxidize the surface. The bomb was then cooled to ambient temperature, and a weighed witness coupon (made of stainless steel) was placed inside the bomb.

The bomb was then evacuated, and subsequently charged with the fluid to be tested (and, optionally, air), by injection through a septum, using a gas-tight syringe. The bomb was then sealed. The amount of air charged was calculated, based on the desired, initial oxygen concentration. The bomb was then weighed and placed in the oven at 300° C. for 60 hours. After this exposure time, the bomb was removed from the oven, cooled, and weighed, to determine whether a leak had occurred. The headspace of the bomb was sampled, by withdrawing a sample to a second, evacuated 10 cc bomb, followed by chromatographic analysis (GC-MS). The first 10 cc bomb was then opened for inspection and weighing of the coupon, and for analysis of the liquid sample. Headspace acidity was measured by moistened EM Merck pH strips that were suspended inside the first 10 cc bomb for 15 seconds, after unsealing, but before removing the liquid. Table 1 provides a summary of the content of each sample that was tested; and related properties and characteristics.

TABLE 1

| | Sample | | | |
|---|---|---|---|---|
| | | | C | D |
| | | | Thiophene + | Thiophene + |
| | A | B | 10% Cyclo- | 10% Iso- |
| | Thiophene | Thiophene | pentane | pentane |
| Fluid Charge | 0.546 | 0.572 | 0.537 | 0.529 |
| (g) | | | | |
| Air charge (cc) | — | 0.75 | 0.75 | 0.75 |
| Witness | | | | |
| Coupon: | | | | |
| After Heating | 0.1585 | 0.1823 | 0.1876 | 0.1867 |
| (g) | | | | |
| Initial (g) | 0.1585 | 0.1824 | 0.1876 | 0.1866 |
| Delta (g) | 0.0000 | −0.0001 | 0.0000 | +0.0001 |
| Appearance | Bright | Discolored | Discolored | Discolored |
| Liquid | Clear | Light yellow | Dark yellow | Yellow |
| Appearance | | | | |
| pH of Vapor | 5 | 2-3 | 4-5 | 4-5 |
| Headspace | | | | |
| GC/MS* | | | | |
| COS** | 0.7 | 28.1 | 6.7 | 7.9 |
| SO₂ | 0.8 | 7.1 | 3.2 | 0.7 |
| CS₂*** | 0.2 | 2.3 | 2.1 | 0.7 |

*Gas chromatography/mass spectrometry; area of parent ion peak as percentage of fragment, with m/e = 60 for thiophene
**Carbonyl sulfide
***Carbon disulfide

Compositions A and B were comparative samples, and did not include the hydrocarbon constituent. As indicated for samples B, C, and D, the stainless steel witness coupon became discolored in the presence of air, which was expected. In the case of sample B, the light yellow appearance of the liquid was an indication that the thiophene component, without any hydrocarbon being present, was undergoing some degree of degradation. The increased vapor acidity (shown by a lower pH as compared to sample A) was attributable to the presence of acidic byproducts like COS, SO₂, and CS₂, which was another indication of thiophene degradation.

Samples C and D were within the scope of the present invention. In the case of sample C, the dark yellow liquid color was a favorable result, indicating that the cyclopentane component was being sacrificially oxidized, i.e., in preference to any degradation or decomposition of the thiophene. Similar results were seen with sample D, which employed isopentane as the hydrocarbon constituent. Moreover, the higher pH values for samples C and D, as compared to sample B, indicated that the amount of acidic byproducts being formed was considerably decreased. The relatively low levels of COS, SO₂, and CS₂ provide further support for this conclusion.

It is clear that the thiophene portion of the compositions corresponding to samples C and D are thermally- and chemically more stable at elevated temperatures in the presence of oxygen, as compared to the thiophene in sample B. Thus, the advantages of using organic working fluids based on these thiophene-hydrocarbon compositions is also apparent. Moreover, these working fluids are relatively economical to prepare and use, and, in general, are fully compatible with heat recovery systems currently in use.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

1. A heat recovery system, comprising a thermally-stable, organic working fluid which itself comprises a mixture of thiophene or a derivative thereof, and at least one hydrocarbon having a boiling point in the range of about 25° C. to about 125° C., wherein the hydrocarbon is present at a level of about 1% to about 25% by weight, based on the weight of the mixture.

2. The heat recovery system of claim 1, wherein the hydrocarbon is at least one aromatic compound.

3. The heat recovery system of claim 2, wherein the aromatic compound is toluene, a xylene compound, or combinations thereof.

4. The heat recovery system of claim 1, wherein the hydrocarbon is at least one aliphatic compound.

5. The heat recovery system of claim 4, wherein the aliphatic compound is selected from the group consisting of iso-pentane; n-pentane; 2,3-dimethylbutane; 2,2-dimethylbutane; 2-methylpentane; 3-methylpentane; n-hexane; 2,2-dimethylpentane; 2,4-dimethylpentane; 2,2,3-trimethylbutane; 3,3-dimethylpentane; 2,3-dimethylpentane; 2-methylhexane; 3-methylhexane; 3-ethylpentane; n-heptane; 2,2,4-trimethylpentane; 2,2-dimethylhexane; 2,5-dimethylhexane; 2,4-dimethylhexane; 2,2,3-trimethylpentane; 3,3-dimethylhexane; 2,3,4-trimethylpentane; 2,3,3-trimethylpentane; 2,3-dimethylhexane; 2-methylheptane; 4-methylheptane; 3,4-dimethylhexane; 3-methyl-3-ethylpentane; 3-ethylhexane; 3-methylheptane; 2,2,4,4-tetraethylpentane; 2,2,5-trimethylhexane; n-octane; 2,2,4-trimethylhexane; and combinations thereof.

6. The heat recovery system of claim 5, wherein the aliphatic compound is selected from the group consisting of iso-pentane, n-pentane, 2-methylpentane; 3-methylpentane; n-hexane; and combinations thereof.

7. The heat recovery system of claim 4, wherein the aliphatic compound is cycloaliphatic.

8. The heat recovery system of claim 7, wherein the cycloaliphatic compound is selected from the group consisting of cyclopentane; methylcyclopentane; cyclohexane; 1,1-dimethylcyclopentane; trans-1,2 dimethylcyclopentane; cis-1,2 dimethylcyclopentane; methylcyclohexane; ethylcyclopentane; 1,1,3-trimethylcyclopropane; cis-trans-cis-1,2,4-trimethylcyclopropane; 1,1,2-trimethylcyclopropane; cis-cis-trans-1,2,4-trimethylcyclopropane; cycloheptane; trans-1,4-dimethylcyclohexane; 1,1-dimethylcyclohexane; cis-1,3-dimethylcyclohexane; 1-methyl-1-ethylcyclopropane; trans-1,2-dimethylcyclohexane; cis-1,4-dimethylcyclohexane; trans-1,3-dimethylcyclohexane; and combinations thereof.

9. The heat recovery system of claim 8, wherein the cycloaliphatic compound is selected from the group consisting of cyclopentane; methylcyclopentane; cyclohexane, and combinations thereof.

10. The heat recovery system of claim 1, wherein the hydrocarbon is present at a level of about 5% to about 10% by weight, based on the weight of the mixture.

11. The heat recovery system of claim 1, comprising:
(a) an evaporator in which the organic working fluid is vaporized, said evaporator being connected to a heat source;
(b) a turbine-generator system in communication with the evaporator, for accepting the vaporized working fluid, and allowing the working fluid to expand and produce electrical power;
(c) an organic fluid condenser, in communication with the turbine-generator system, for condensing the expanded working fluid after it exits the turbine-generator system; and
(d) a pump, in direct or indirect communication with both the evaporator and the condenser, for returning the condensed working fluid to the evaporator.

12. The heat recovery system of claim 11, wherein the heat source is a heat-generation system selected from the group consisting of a combustion engine, a combustion turbine; a nuclear power plant, a coal-burning plant; a coal gasification plant; a steam plant, a geothermal system, a biomass combustion system, a biomass gasification system; a petroleum coke gasification system; a municipal waste combustion system; a municipal solid waste gasification system; a space heating assembly; a cooling system; and combinations thereof.

13. A waste-heat recovery system, comprising at least one organic working cycle which includes a working fluid, wherein the working fluid comprises a mixture of thiophene or a derivative thereof, and at least one hydrocarbon having a boiling point in the range of about 25° C. to about 125° C., and the hydrocarbon is present at a level of about 1% to about 25% by weight, based on the weight of the mixture.

14. A method for recovering waste-heat from a power plant, comprising the step of directing the waste-heat to the heat-recovery system of claim 11, so as to function as at least a part of the heat source in the system, according to step (a).

15. The method of claim 14, wherein the waste-heat is directed to the heat-recovery system at a temperature in the range of about 200° C. to about 600° C.

16. A photometric sensor system for the detection of oxidative activity in an industrial process which is carried out at elevated temperatures, and which utilizes at least one fluid, wherein the sensor comprises:
(I) a portion of the fluid, wherein the fluid comprises a mixture of a thiophene-based compound and at least one hydrocarbon, and is oxygen-sensitive; and
(II) at least one detector in optical contact with the fluid, and capable of detecting if a color change has occurred in the fluid;
wherein the oxygen-sensitive fluid possesses a specific color at an initial time setting, and then undergoes a measurable color change over time, and the color change can be correlated to oxidation of the hydrocarbon, which is indicative of oxidative activity in the industrial process.

17. The photometric sensor system of claim 16, wherein the detector of element (II) comprises a color-sensitive photocell.

18. A heat-recovery system which includes at least one organic rankine cycle, and further comprises the photometric sensor system of claim 16 as part of the organic rankine cycle, wherein a working fluid of the rankine cycle is the oxygen-sensitive mixture of the thiophene-based compound and the hydrocarbon.

19. A method for detecting oxidative activity in an industrial process which is carried out at elevated temperatures, and which utilizes at least one fluid, wherein the fluid comprises a mixture of a thiophene-based compound and at least one hydrocarbon, and is oxygen-sensitive;
said method comprising the step of measuring color changes in the fluid with a color-change detector; wherein the oxygen-sensitive fluid possesses a specific color at an initial time setting, and then undergoes a measurable color change over time, and the color change can be correlated to oxidation of the hydrocarbon, which is indicative of oxidative activity in the industrial process.

20. The method of claim 19, wherein the industrial process is a heat-recovery system which utilizes at least one organic rankine cycle; and the fluid is a working fluid for the organic rankine cycle.
